(19) United States
(12) Patent Application Publication
(10) Pub. No.: US 2025/0200421 A1
(43) Pub. Date: Jun. 19, 2025

(54) SYSTEM AND METHOD FOR LEARNING STABLE MODELS

(71) Applicant: YAHOO ASSETS LLC, New York, NY (US)

(72) Inventors: Noa Avigdor-Elgrabli, New York, NY (US); Ran Wolff, New York, NY (US)

(21) Appl. No.: 18/538,688

(22) Filed: Dec. 13, 2023

(51) Int. Cl. G06N 20/00

(52) U.S. Cl. CPC G06N 20/00

(57) ABSTRACT

The present teaching relates to learning a model. Supervised training data with samples having feature values and a label is received. Unlabeled data be classified is received having samples with values of the same features. Un-stationary features in the supervised training data are detected based on respective feature values from the supervised training data and the unlabeled data. If un-stationary feature exists, adjusted training data set is created based on the supervised training data and the un-stationary features and used to train a stationary classification model. Otherwise, the supervised training data is used to train the stationary classification model.

### BACKGROUND

### 1. Technical Field

The present teaching generally relates to computers. More specifically, the present teaching relates to machine learning.

### 2. Technical Background

With the development of the different techniques on artificial intelligence (AI), learning models based on training data to perform certain decision-making tasks has become more and more prevalent. Data may be collected from past operations of a relevant application and used to generated training data to be provided to a machine learning mechanism to train a model to learn knowledge in making decisions like what is represented by the training data. Training data may comprise various tuples, each of which includes situation data and decision data. The situation data may correspond to different types of information associated with a situation and the decision data may correspond to a decision made for the underlying application based on the situation data. For example, in content recommendation (application), situation data may include features such as an identity of a user, a personal profile of the user, a webpage the user is interacting with, the searches performed by the user, trending topics, content topics available to the operator of the webpage, etc. Decision data in this exemplary application may be a recommended topic of content to be recommended to the user. When such situation and decision data are collected from past user content consumption activities, they may be used to train a model to recommend a topic of content to be recommended to a user given the situation data associated with the user in each scenario.

The performance of a learned model may depend on different factors. For example, the representativeness of the training data with respect to the underlying application may have a crucial effect on the model. However, it may be difficult to obtain comprehensive training data to cover all scenarios, especially when the dynamics associated with an application may not be predictable. For instance, value distributions of features related to seasons and trends may change over time and some may not change in a predictable manner. That is, in general, training data may include unstable features. Given that, the models learned using training data may not reflect the situation at the time the model is relied on to make a decision. Efforts have been made to overcome this issue. For example, training data may be continually collected, and the model may be completely re-trained regularly using the most relevant training data (e.g., most recent). This approach may be expensive because of the regular re-training. Another effort is to perform time series analysis with respect to each feature in the training data, which requires data collected from a long period in order to be effective.

Thus, there is a need for a solution that address the problem in training models due to unstable features.

### SUMMARY

The teachings disclosed herein relate to methods, systems, and programming for information management. More particularly, the present teaching relates to methods, systems, and programming related to content processing and categorization.

In one example, a method, implemented on a machine having at least one processor, storage, and a communication platform capable of connecting to a network for learning a model. Supervised training data with samples having feature values and a label is received. Unlabeled data be classified is received having samples with values of the same features. Un-stationary features in the supervised training data are detected based on respective feature values from the supervised training data and the unlabeled data. If un-stationary feature exists, adjusted training data set is created based on the supervised training data and the un-stationary features and used to train a stationary classification model. Otherwise, the supervised training data is used to train the stationary classification model.

In a different example, a system is disclosed for learning a model and includes an un-stationary feature detector and a supervised stationary model training engine. The un-stationary feature detector is provided for receiving supervised training data and unlabeled data to be classified, where the supervised training data include data samples, each with values of features and a label and the unlabeled data has values of the same features, and are used to determine whether any of the corresponding features is un-stationary in the supervised training data. If any un-stationary features is detected, adjusted supervised training data is created based on the supervised training data and the detected un-stationary features and used for training a stationary classification model. Otherwise, the stationary classification model is trained based on the supervised training data set.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for learning a model. Supervised training data with samples having feature values and a label is received. Unlabeled data be classified is received having samples with values of the same features. Un-stationary features in the supervised training data are detected based on respective feature values from the supervised training data and the unlabeled data. If un-stationary feature exists, adjusted training data set is created based on the supervised training data and the un-stationary features and used to train a stationary classification model. Otherwise, the supervised training data is used to train the stationary classification model.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A depicts an exemplary framework for learning stable models, in accordance with an embodiment of the present teaching;

FIG. 1B is a flowchart of an exemplary framework for learning stable models, in accordance with an embodiment of the present teaching;

FIG. 2A depicts an exemplary high-level system diagram of an un-stationary feature detector, in accordance with an embodiment of the present teaching;

FIG. 2B is a flowchart of an exemplary process of an un-stationary feature detector, in accordance with an embodiment of the present teaching;

FIG. 3A depicts an exemplary high-level system diagram of a supervised stationary model training engine, in accordance with an embodiment of the present teaching;

FIG. 3B is a flowchart of an exemplary process of a supervised stationary model training engine, in accordance with an embodiment of the present teaching;

FIG. 4 is an illustrative diagram of an exemplary mobile device architecture that may be used to realize a specialized system implementing the present teaching in accordance with various embodiments; and

FIG. 5 is an illustrative diagram of an exemplary computing device architecture that may be used to realize a specialized system implementing the present teaching in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

The present teaching discloses a framework for adaptively training a stable or stationary model by dynamically detecting un-stationary features and eliminating or minimizing the impact of such un-stationary features in training the model. A training mechanism utilizes a training data set with ground truth labels for learning to obtain a model that can be used to predict labels of unlabeled data. Such a trained model works well if the feature values in the training data set have the same or similar distributions as that in the unlabeled data. An un-stationary feature is defined as one whose value distribution in the training data is not the same or similar to that in the unlabeled data. When un-stationary features are present, the predictive power of the model degrades. However, the un-stationary features may change over time. That is, an un-stationary feature at some time may no longer be un-stationary. Similarly, a stationary feature at some time may become un-stationary later.

The present teaching discloses methods and systems to dynamically detecting un-stationary features with respect to training data and unlabeled data set and then accordingly eliminate or minimize the impact of the detected un-stationary features in training a model. In some embodiments, an un-stationary feature may be identified by detecting a distribution change based on, e.g., statistical tests. When remaining stationary features provide adequate predictive power, a model may be trained in a manner to remove the impact of the un-stationary features. In some embodiments, the impact of the un-stationary feature may be eliminated by excluding a part of the training data associated with the un-stationary features in training the model. In some embodiments, the impact of the un-stationary features may be minimized through adjusting the weights added to the values of the un-stationary features. For example, a weight may be applied to each of the features in the training data and may be dynamically adjusted based on, e.g., a level of consistency between its value distribution and that of the unlabeled data set. The higher the level of consistency, the higher the predictive power of the feature. On the other hand, the higher the level of inconsistency, the lower the weight assigned to the feature to reduce its impact to the model.

As feature selection according to the present teaching is based on the predictive power of each feature with respect to a specific unlabeled data set, different features may be detected as un-stationary with respect to different unlabeled data sets. It makes it possible to adapt the model to a problem in hand or to the fluctuation in the unlabeled data sets collected over time in the same application. As such, a model to be trained for an application may be dynamically adjusted to yield a stable model in terms of predictive power with respect to the data to be classified. The approach according to the present teaching provides an improvement to the conventional techniques because it enables training of stable models yet does not require continuous collection of labeled data or time series analysis based on data collected over a long period of time.

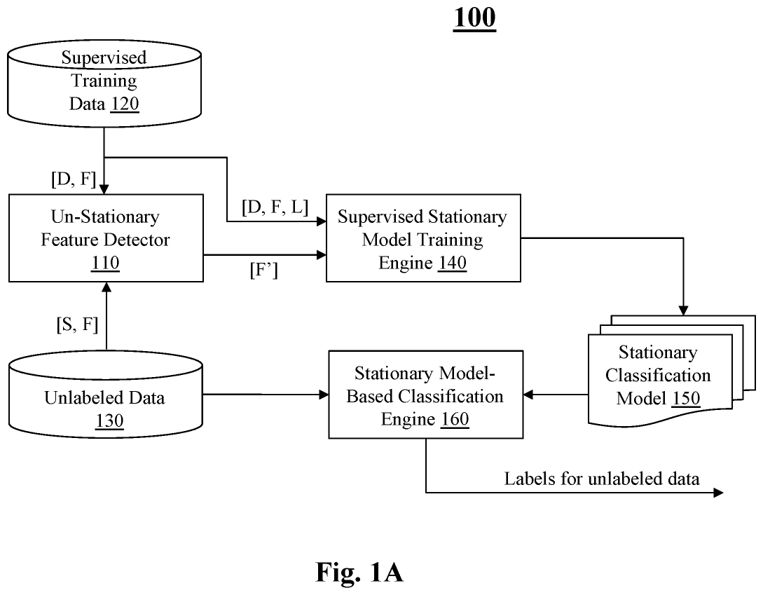

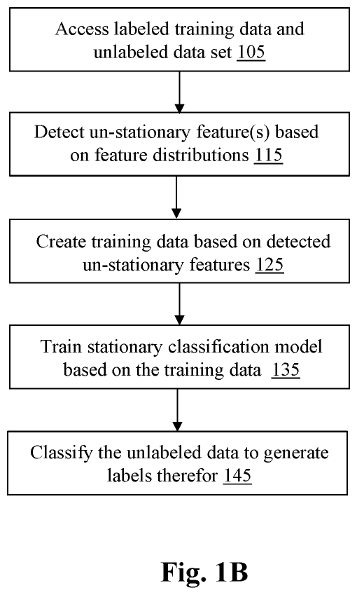

FIG. 1A depicts an exemplary framework 100 for learning a stable model and a classification application thereof, in accordance with an embodiment of the present teaching. In this illustrated embodiment, the framework 100 comprises an un-stationary feature detector 110, a supervised stationary model training engine 140, and a stationary model-based classification engine 160. In this framework 100, there is a supervised training data set 120, corresponding to a training data set for training a stationary classification model 150. There is also an unlabeled data set 130, corresponding to a data set with samples to be labeled using the trained stationary classification model 150. The training data set 120 includes a data set D with a feature set F and a label set L. Each sample i in D has a value vi,j for each feature fj in F and a label value li in L. The unlabeled data set 130 has a data set S and the feature set F with each sample i in S having a value si,j for each feature fj in F. Each sample in S needs to be labeled or classified based on the stationary classification model 150.

Based on the training data set 120 and the unlabeled data set 130, the un-stationary feature detector 110 is provided to identify un-stationary features [F′]. The supervised stationary model training engine 140 is provided to train the stationary classification model 150 using a modified training data set, e.g., [D. F-F′, L], derived based on the [D, F, L] from 120 and the detected un-stationary features [F′]. In some embodiments, F-F′ may be implemented by removing features in [F′] from F. In some embodiments, F-F′ may be implemented by adjusting the weights to features in F according to the detection result so that the un-stationary features in F′ may be given minimum weights to reduce their impact during training. Training based on the modified training data set [D, F-F′, L] yields the stationary classification model 150. The stationary model-based classification engine 160 may then classify each sample in the unlabeled data set 130 based on the trained stationary classification model 150 and assigned labels to the samples in unlabeled data set 130.

FIG. 1B is a flowchart of an exemplary framework for learning the stable model 150 for stable classification, in accordance with an embodiment of the present teaching. The un-stationary feature detector 110 first accesses, at 105, the supervised training data 120 [D, F, L] and the unlabeled data set 130 [S, F] and detects, at 115, un-stationary features [F′]. As discussed herein, an un-stationary feature may be identified based on a feature value distribution change from the distribute in the supervised training data set 120 to that in the unlabeled data set 130. In some embodiments, a distribution change may be detected via, e.g., statistical tests, which answer the question on whether two samples are sampled from the same distribution. For example, Kolmogorov-Smirnov test, t-test, Mann-Whitney U test are exemplary statistical test methods that may be used to detect a distribution change with respect to a feature.

Based on the detected un-stationary features [F′], the supervised stationary model training engine 140 creates, at 125, a training data set that is to be used for the actual training. As discussed herein, in some embodiments, a modified training data set [D, F-F′, L] may be created with F-F′ being derived by either removing the un-stationary features F′ or assigning minimized weights to features in F′ to eliminate their impact to the training. Such created actual training data set may then be used to train, at 135, the stationary classification model. With the trained stationary classification model 150, the stationary model-based classification engine 160 classifies, at 145, the samples in the unlabeled data set 130 and assign labels thereto.

The operation as disclosed herein to obtain a stable classification model via supervised training using stable training data according to the present teaching may be regularly carried out in an application. In some embodiments, the unlabeled data set 130 may correspond to batch data. In this case, each time there is a new batch, the adaptation of the stationary classification model 150 may be carried out by detecting again the un-stationary features with respect to the new batch. In some embodiments, the adaptation may be carried out according to some specified time interval, e.g., daily or weekly. In some embodiments, the adaptation may be triggered by, e.g., performance of the stationary classification model 150.

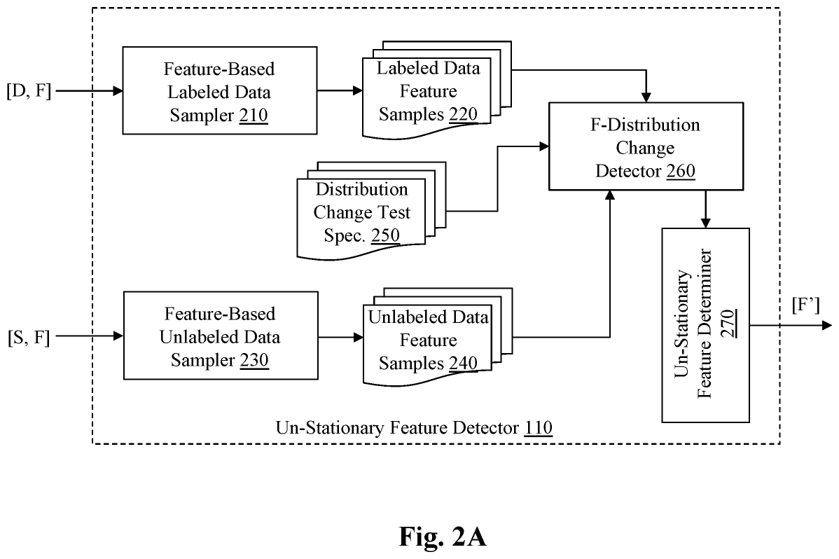

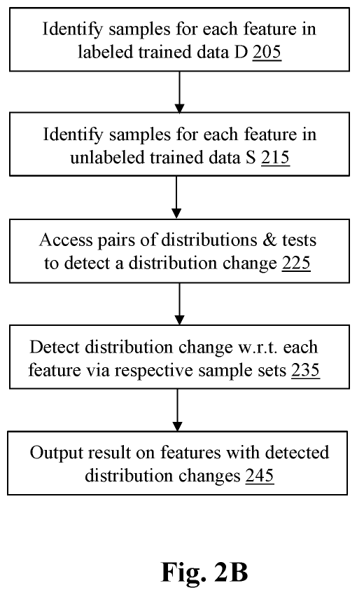

FIG. 2A depicts an exemplary high-level system diagram of the un-stationary feature detector 110, in accordance with an embodiment of the present teaching. As discussed herein, the detection of un-stationary features may be carried out with respect to each feature by recognizing a feature value distribution change between the training data set [D, F, L] and the unlabeled data set [S, F]. To do so, the un-stationary feature detector 110 comprises a feature-based labeled data sampler 210, a feature-based unlabeled data sampler 230, a feature-distribution change detector 260, and an un-stationary feature determiner 270. The feature-based labeled data sampler 210 is provided for gathering, with respect to each of the features in F, feature values of different samples in the supervised training data 120 so that the distribution of the feature values from the supervised training data 120 may be used for detection. Such generated feature values for each of the features in F from the supervised training data 120 are stored in labeled data feature samples 220. The feature-based unlabeled data sampler 230 is provided for gathering, with respect to each of the features in F, feature values of different samples in the unlabeled data set 130. The gathered feature values for each of the features in F from the unlabeled data set 130 are stored in unlabeled data feature samples 240.

The F-distribution change detector 260 is provided for detecting a distribution change based on two distributions represented by two sets of feature values, one from the labeled data feature samples 220 and the other from the unlabeled data feature samples 240 corresponding to the same feature. As discussed herein, in some embodiments, the detection of a distribution change is based on some statistical test, configured, e.g., in a distribution change test specification 250. If a feature is determined to be un-stationary, it is identified as such. The un-stationary feature determiner 270 is provided for generating an identified set of un-stationary features [F′] based on the comparison result and outputs [F′].

FIG. 2B is a flowchart of an exemplary process of the un-stationary feature detector 110, in accordance with an embodiment of the present teaching. The feature-based labeled data sampler 210 identifies, at 205, sample values, with respect to each of the features in F, from the supervised training data 120 to form a set of values representing a distribution of the feature values from the supervised training data set and saves the set for the feature values in the labeled data feature samples 220. Correspondingly, the feature-based unlabeled data sampler 230 identifies, at 215, sample values, with respect to each of the features in F, from the unlabeled data set 130 to form a set of values representing a distribution of the feature values from the unlabeled data set and saves the set for the feature values in the unlabeled data feature samples 240. The F-distribution change detector 260 accesses, at 225, each pair of distributions (from the supervised and unlabeled data set, respectively) with respect to the same feature the configured test(s) (specified in 250) to be performed to detect, at 235, whether there is a distribution change of each feature. If there is a distribution change, the underlying feature is deemed as un-stationary. Based on such detection, the un-stationary feature determiner 270 generates the [F′] and outputs, at 245, the detection result.

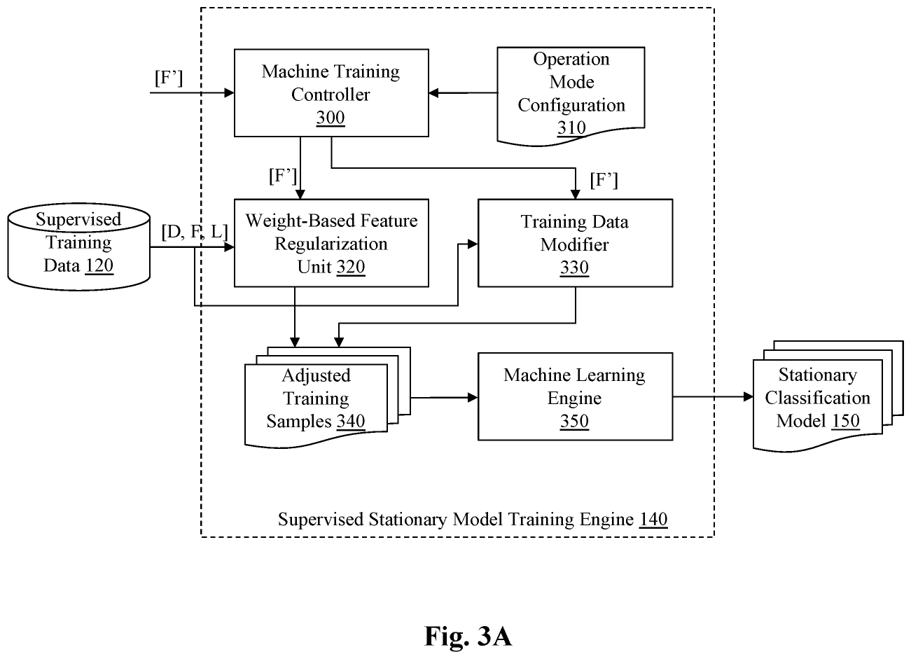

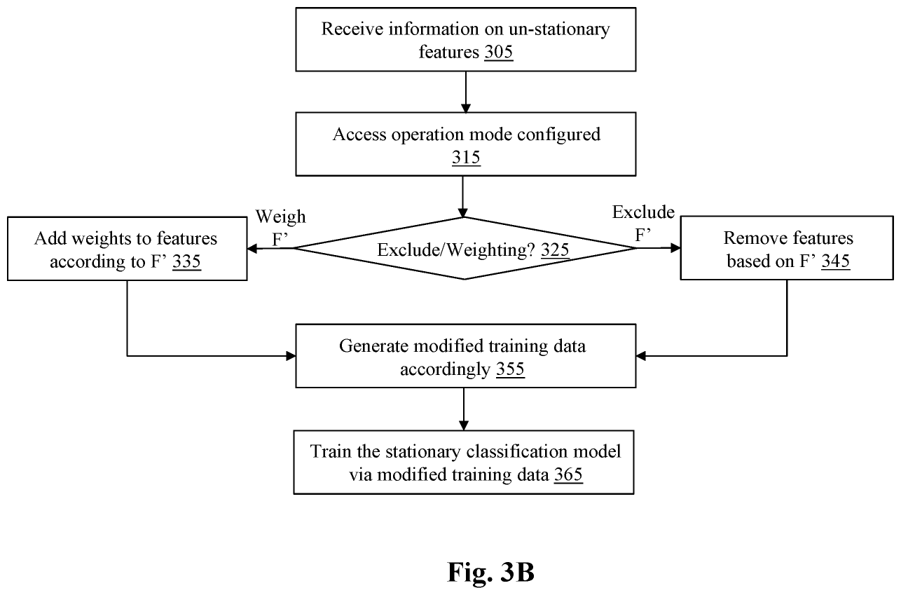

FIG. 3A depicts an exemplary high-level system diagram of the supervised stationary model training engine 140, in accordance with an embodiment of the present teaching. As discussed herein, once un-stationary features are identified, the stationary classification model 150 may be trained in one of the operations modes corresponding to different ways to eliminate or minimize the impact of such features to the training of the stationary classification model 150. In this illustrated embodiment, the supervised stationary model training engine 140 comprises a machine learning controller 300, a weight-based feature regularization unit 320, a training data modifier 330, and a machine learning engine 350. The machine learning controller 300 may be provided to determine an operation mode specified in an operation mode configuration 310 and controls the learning operation accordingly. In the illustrated embodiment, one of the operation modes is to weigh the features in the supervised training data set 120 according to the un-stationary feature detection result. Another operation mode is to remove the detected un-stationary features from the supervised training data set 120 to eliminate their impact in learning.

In the operation mode of weighing features according to un-stationary feature detection result, the weight-based feature regularization unit 320 may be invoked to determine the weight to each of the features. In some embodiments, the weight to an un-stationary feature may be set to zero or a small value, which may be determined proportionally to the level of change of the underlying feature value distribution to indicate the impact of the un-stationary feature allowed during training. The stationary features may be weighed differently indicative of allowing them to contribute to the model training. In some embodiments, the weights applied to the stationary features may be equal, indicating that stationary features may equally contribute to the learning. Such weighted features may be incorporated into the supervised training data set 120 to generate adjusted training samples 340. Such adjusted training samples 340 may later be used for training the stationary classification model 150. As the impact of the detected un-stationary features is minimized via weighing, the adjusted training samples enables derivation, via machine learning, of the stationary classification model 150.

In the operation mode of generating a modified training data set according to the un-stationary feature detection result, the training data modifier 330 may be invoked and remove the un-stationary features and their corresponding values from the supervised training data 120 to generate adjusted training samples 340, which may later be used for training the stationary classification model 150. In this operational mode, as the un-stationary features have been removed in the adjusted training samples 340, the stationary classification model 150 trained using such training data yields a mode that is stable. With the adjusted training samples 340, obtained in either of the operation mode as discussed herein, the machine learning engine 350 is invoked to train, via machine learning, the stationary classification model 150 using the adjusted training samples 340.

FIG. 3B is a flowchart of an exemplary process of the supervised stationary model training engine 140, in accordance with an embodiment of the present teaching. When the information about un-stationary features, i.e., [F′], is received at 305, the machine training controller 300 accesses, at 315, the operation mode configured in 310. Depending on the operation mode, determined at 325, the machine training controller 300 invokes either the weight-based feature regularization unit 320 or the training data modifier 330 to generate adjusted training samples 340. When the weight-based feature regularization unit 320 is invoked, it determines the weights to be used with respect to features in the supervised training data set 120 and add, at 335, such weights to the features to specify their respective predictive power. The weights and the supervised training data set may then be used to generate, at 355, the adjusted training samples 340. In another operation mode, the training data modifier 330 may proceed to remove the un-stationary features from the supervised training data set 120 to generate, at 355, a modified or adjusted training samples 340. The machine learning engine 350 may then use the adjusted training samples 340 to train, at 365, the stationary classification model 150.

The learning scheme for learning a stable model according to the present teaching may be used to capture sudden and/or unpredictable changes between current data to be classified and the training data. As discussed herein, although time series analysis may be used to capture such a change, it can achieve the same only after the fact and requires in general evidence over an extended period. The conventional re-training of a model also requires collecting additional labeled data. The approach as disclosed herein may be used to capture such a change on-the-fly while it is happening without needing previously collected evidential data associated with the change.

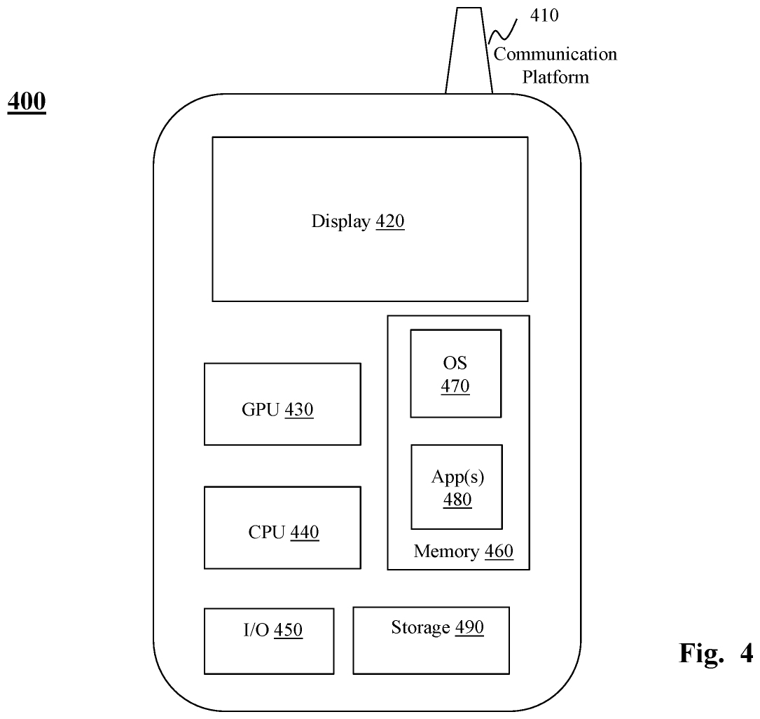

FIG. 4 is an illustrative diagram of an exemplary mobile device architecture that may be used to realize a specialized system implementing the present teaching in accordance with various embodiments. In this example, the user device on which the present teaching may be implemented corresponds to a mobile device 400, including, but not limited to, a smart phone, a tablet, a music player, a handled gaming console, a global positioning system (GPS) receiver, and a wearable computing device, or in any other form factor. Mobile device 400 may include one or more central processing units (“CPUs”) 440, one or more graphic processing units (“GPUs”) 430, a display 420, a memory 460, a communication platform 410, such as a wireless communication module, storage 490, and one or more input/output (I/O) devices 450. Any other suitable component, including but not limited to a system bus or a controller (not shown), may also be included in the mobile device 400. As shown in FIG. 4, a mobile operating system 470 (e.g., iOS, Android, Windows Phone, etc.), and one or more applications 480 may be loaded into memory 460 from storage 490 in order to be executed by the CPU 440. The applications 480 may include a user interface or any other suitable mobile apps for information analytics and management according to the present teaching on, at least partially, the mobile device 400. User interactions, if any, may be achieved via the I/O devices 450 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

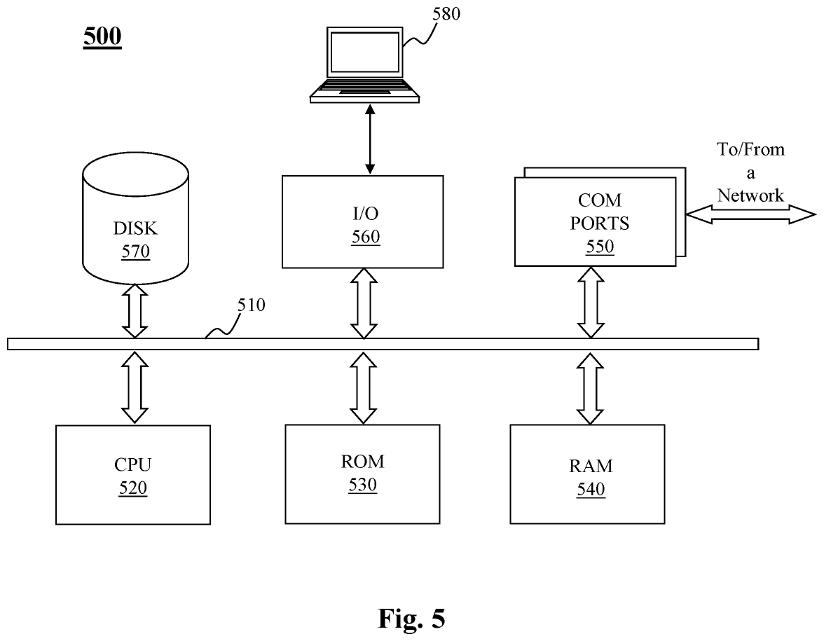

FIG. 5 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 500 may be used to implement any component or aspect of the framework as disclosed herein. For example, the information analytical and management method and system as disclosed herein may be implemented on a computer such as computer 500, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 500, for example, includes COM ports 550 connected to and from a network connected thereto to facilitate data communications. Computer 500 also includes a central processing unit (CPU) 520, in the form of one or more processors, for executing program instructions. The exemplary computer platform includes an internal communication bus 510, program storage and data storage of different forms (e.g., disk 570, read only memory (ROM) 530, or random-access memory (RAM) 540), for various data files to be processed and/or communicated by computer 500, as well as possibly program instructions to be executed by CPU 520. Computer 500 also includes an I/O component 560, supporting input/output flows between the computer and other components therein such as user interface elements 580. Computer 500 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, comprising:
receiving supervised training data set, having data samples each of which includes values of corresponding features and a label representing a classification of the data sample;
receiving unlabeled data set, having data samples each of which includes values of the corresponding features and is to be classified;
detecting whether any of the corresponding features is un-stationary in the supervised training data set based on values of features in the supervised training data set and values of features in the unlabeled data set to obtain an un-stationary feature detection result;
if the un-stationary feature detection result indicates that un-stationary feature exists,
generating an adjusted supervised training data set based on the supervised training data set according to the un-stationary feature detection result,
training, via machine learning, a stationary classification model based on the adjusted supervised training data set; and
if no un-stationary feature exists, training, via machine learning, the stationary classification model based on the supervised training data set.

2. The method of claim 1, further comprising classifying, based on the stationary classification model, each of the data samples in the unlabeled data set with a label determined according to the classification.

3. The method of claim 1, wherein the step of detecting comprises:
with respect to each of the corresponding features,
obtaining a first value distribution based on values of the corresponding feature in the supervised training data set,
obtaining a second value distribution based on values of the corresponding feature in the unlabeled data set, and
determining the corresponding feature to be an un-stationary feature if there is a distribution change between the first value distribution and the second value distribution of the corresponding feature.

4. The method of claim 3, wherein the distribution change is detected via a statistical test.

5. The method of claim 1, wherein the generating the adjusted supervised training data set comprises:
identifying one or more un-stationary features based on the un-stationary feature detection result;
creating the adjusted supervised training data set with minimized influence from the one or more un-stationary features.

6. The method of claim 5, wherein the minimized influence is realized by removing the one or more un-stationary features from the supervised training data set.

7. The method of claim 5, wherein the minimized influence is realized by weighing each of the corresponding features in the supervised training data set with minimal weights applied to the one or more un-stationary features.

8. A machine-readable and non-transitory medium having information recorded thereon, wherein the information, when read by the machine, causes the machine to perform the following steps:
receiving supervised training data set, having data samples each of which includes values of corresponding features and a label representing a classification of the data sample;
receiving unlabeled data set, having data samples each of which includes values of the corresponding features and is to be classified;
detecting whether any of the corresponding features is un-stationary in the supervised training data set based on values of features in the supervised training data set and values of features in the unlabeled data set to obtain an un-stationary feature detection result;
if the un-stationary feature detection result indicates that un-stationary feature exists,
generating an adjusted supervised training data set based on the supervised training data set according to the un-stationary feature detection result,
training, via machine learning, a stationary classification model based on the adjusted supervised training data set; and
if no un-stationary feature exists, training, via machine learning, the stationary classification model based on the supervised training data set.

9. The medium of claim 8, wherein the information, when read by the machine, further causes the machine to perform the step of classifying, based on the stationary classification model, each of the data samples in the unlabeled data set with a label determined according to the classification.

10. The medium of claim 8, wherein the step of detecting comprises:
with respect to each of the corresponding features,
obtaining a first value distribution based on values of the corresponding feature in the supervised training data set,
obtaining a second value distribution based on values of the corresponding feature in the unlabeled data set, and
determining the corresponding feature to be an un-stationary feature if there is a distribution change between the first value distribution and the second value distribution of the corresponding feature.

11. The medium of claim 10, wherein the distribution change is detected via a statistical test.

12. The medium of claim 8, wherein the generating the adjusted supervised training data set comprises:
identifying one or more un-stationary features based on the un-stationary feature detection result;
creating the adjusted supervised training data set with minimized influence from the one or more un-stationary features.

13. The medium of claim 12, wherein the minimized influence is realized by removing the one or more un-stationary features from the supervised training data set.

14. The medium of claim 12, wherein the minimized influence is realized by weighing each of the corresponding features in the supervised training data set with minimal weights applied to the one or more un-stationary features.

15. A system, comprising:
an un-stationary feature detector implemented by a processor and configured for
receiving supervised training data set, having data samples each of which includes values of corresponding features and a label representing a classification of the data sample,
receiving unlabeled data set, having data samples each of which includes values of the corresponding features and is to be classified, and
detecting whether any of the corresponding features is un-stationary in the supervised training data set based on values of features in the supervised training data set and values of features in the unlabeled data set to obtain an un-stationary feature detection result; and
a supervised stationary model training engine implemented by a processor and configured for:
if the un-stationary feature detection result indicates that un-stationary feature exists,
generating an adjusted supervised training data set based on the supervised training data set according to the un-stationary feature detection result,
training, via machine learning, a stationary classification model based on the adjusted supervised training data set, and
if no un-stationary feature exists, training, via machine learning, the stationary classification model based on the supervised training data set.

16. The system of claim 15, further comprising a stationary model-based classification engine implemented by a processor and configured for classifying, based on the stationary classification model, each of the data samples in the unlabeled data set with a label determined according to the classification.

17. The system of claim 15, wherein the step of detecting comprises:
with respect to each of the corresponding features,
obtaining a first value distribution based on values of the corresponding feature in the supervised training data set,
obtaining a second value distribution based on values of the corresponding feature in the unlabeled data set, and
determining the corresponding feature to be an un-stationary feature if there is a distribution change between the first value distribution and the second value distribution of the corresponding feature.

18. The system of claim 17, wherein the distribution change is detected via a statistical test.

19. The system of claim 15, wherein the generating the adjusted supervised training data set comprises:
identifying one or more un-stationary features based on the un-stationary feature detection result;
creating the adjusted supervised training data set with minimized influence from the one or more un-stationary features.

20. The system of claim 19, wherein the minimized influence is realized by at least one of:
removing the one or more un-stationary features from the supervised training data set; and
weighing each of the corresponding features in the supervised training data set with minimal weights applied to the one or more un-stationary features.
